(19) United States
(12) Patent Application Publication
(10) Pub. No.: US 2007/0164553 A1
(43) Pub. Date: Jul. 19, 2007

(54) Coloring book with embedded inwardly foldable stencils

(76) Inventors: Dov Katz, Brooklyn, NY (US); Bezalel Katz, Brooklyn, NY (US)

Correspondence Address: OSTROLENK FABER GERB & SOFFEN, 1180 AVENUE OF THE AMERICAS, NEW YORK, NY, 100368403, US

(21) Appl. No.: 11/333,456

(22) Filed: Jan. 17, 2006

(51) Int. Cl. B42D 1/00

(52) U.S. Cl. 281/38; 283/106

(57) ABSTRACT

A coloring page is constructed of a center section which includes pictures or written matter which requires to be colored. The center section is surrounded by a plurality of stencil panels, each one of which is foldable onto the center section and comprises a stencil pattern which corresponds to a respective one of the various sections of the objects under the center section. The plurality of coloring pages can be bound together, or provided loosely, or held in a loose-leaf binder. The stencil panels are locatable in registration with various objects on the coloring section of the page, whereby a child is enabled to fold different ones of the stencil panels over the center or the page to color in or mark the different objects on the center section, without marking other sections.

### BACKGROUND OF THE INVENTION

The present invention relates to coloring or writing books and the like and more particularly, to such books provided with inwardly foldable stencils that assist and train children to color and/or write more carefully, artistically and neatly.

Coloring and writing books for children are widely known and used in the art. Typically, these books provide to the child various defined spaces within an overall picture or the like, or text formed with a double line pen, for the child to fill the spaces with different colors or just ink or the like or just to trace. Coloring books develop the motor and hand and eye coordination skills of the child and play an important role in the development of the child's writing and drawings skills.

In their initial attempts to use coloring and writing books, children become frustrated due their inability to keep the coloring pen or marker within the bounds indicated in the coloring or writing sheets, which sometimes discourages their need to continue and persevere with the sometimes frustrating learning and developing tasks.

### SUMMARY OF THE INVENTION

It is an object of the present invention to provide children with coloring and writing books that provide initial assistance to children, which makes the learning experience more enjoyable.

The foregoing and other objects of the invention are realized with a coloring or writing book that incorporates within itself fold-in stencils for the child to use in a manner that assures nice and neat results. Thereby, the child's learning experience becomes more pleasurable, and he or she is encouraged to continue working and developing their hand/eye coordination skills.

In accordance with one embodiment of the invention, a page of a coloring book includes on each side edge thereof an extension sheet that constitutes one of several stencils for the given coloring book page, more specifically, one portion or color of the page. For example, each foldable panel may be dedicated for one color marker for the child to fill in on the coloring page.

In accordance with one embodiment of the invention, each coloring page has associated therewith four, or as many as eight, foldable stencil panels. For example, four of the panel may be connected to the coloring page at only one corner edge region thereof.

In accordance with another embodiment of the invention, the stencil panels are bound together and the coloring page is bound into the book at 90°, 180°, or 270°, relative to the hinge line of the stencils so as to be insertable below any one of the stencils.

Other features and advantages of the present invention will become apparent from the following description of the invention which refers to the accompanying drawings.

### BRIEF DESCRIPTION OF THE DRAWINGS

FIG. 1 is a diagram of a coloring page and associated stencils in accordance with an embodiment of the invention.

FIG. 2 is a further diagram of FIG. 1 with two of the stencils partially lifted.

FIG. 3 is an enlargement of a portion of FIG. 1 showing the coloring page.

FIG. 4 shows a second embodiment of the invention.

FIG. 5 shows the second embodiment of the invention with the coloring page positioned for coloring.

FIG. 6 shows a variant of the embodiment of FIG. 1.

### DETAILED DESCRIPTION OF THE DRAWINGS

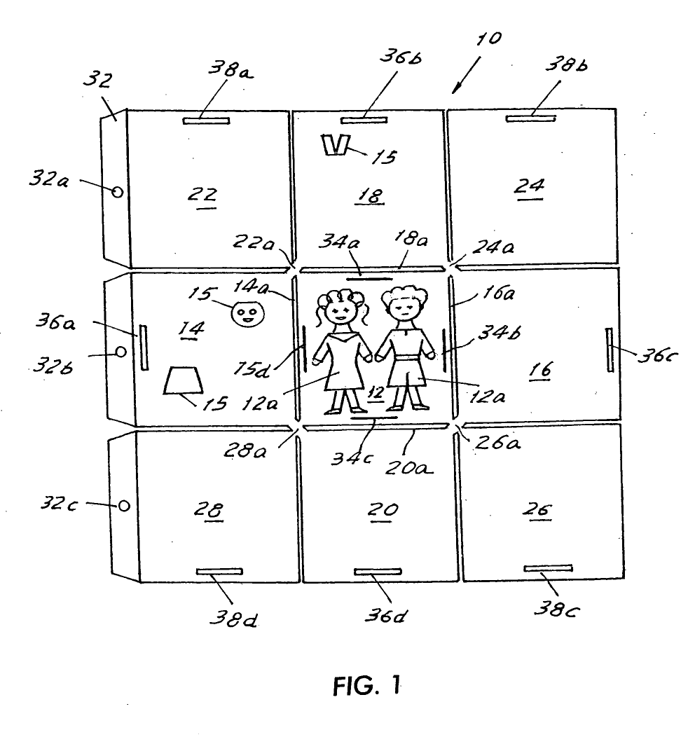

With reference to FIG. 1, a coloring sheet 10, which can be provided as one page in a coloring book or as a removable page in the a loose-leaf bound book, includes centrally located coloring panel 12 surrounded by a number of foldable stencils. In its simpler embodiment, the coloring sheet 12 is flanked by a first foldable stencil panel 14, to the left of the sheet 12, and stencil panels 16, 18 and 20 to the right, to the top and at the bottom, respectively. The stencil panel 14 can be folded along fold line 14a, the panel 16 along fold line 16a, the panel 18 along fold lines 18a and the panel 20 along fold line 20a, in each case onto coloring sheet 12.

The coloring sheet 12 may comprise, as shown in FIG. 3, figure sections 12a-12h, where each section requires filling with a different color. In accordance with the invention, the aforementioned stencil panels 14, 16, 18 and 20 are made of somewhat hardened material with cutouts that define the different areas on the sheet 12 which require different colors to be applied. For example, stencil panel 14 may be folded onto the page 12 to fill the area designated 12a with a particular color. When that task is done, a different panel can be folded onto the page, and so on, with each panel overlapping different areas on the coloring sheet 12.

The coloring sheet need not be limited to pictorial or graphic symbols. For example, it may filled with cursive letters, and the stencils may be used by the child to trace the letters and then enjoy the writing that was created on the sheet 12.

To assist the child in aligning the folding over of a stencil panel onto the sheet 12, alignment grooves 36a, 36b, 36c and 36d may be provided, respectively, on panels 14, 18, 16 and 20, to align with the markings 34b, 34c, 34d and 34a on the sheet 12.

While in its simplest form, a single stencil would be designed to instruct a child to apply one particular color, it is within the ambit of the invention that a single stencil can have several different sections to apply different colors with an indication next to the each cutout section which color is to be applied at the indicated area, such as by providing a color mark adjacent each cutout. Nonetheless, where more than four stencils might be useful to have, the invention provides additional stencil panels such as those provided at the four corners of the coloring page 12, namely the panels 22, 24, 26 and 28. Each of these corner panels is attached to the sheet at a respective web section, for example, at the web sections 22a, 24a, 26a and 28a, so that these panels can be lifted and aligned over the sheet 12, including through the use of the alignment slits, such as the slits 38a, 38b, 38c and 38d which align respectively with the markings 34b, 34d, 34d and 34b, respectively.

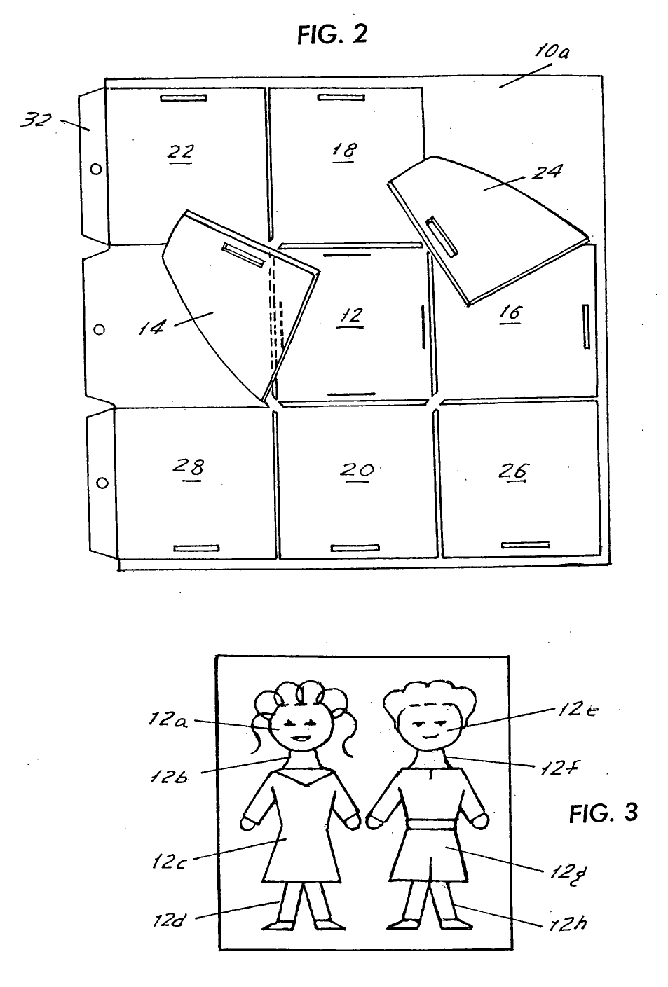

In the embodiment of FIG. 2, the coloring sheet 10 comprises a base page 10a of a size and shape that is large enough to accommodate all of the aforementioned eight sheets, including the coloring sheet 12 and the various stencil panels which are affixed thereto in a manner which allows the stencil panels to be lifted off the base page 10a and folded onto the color sheet 12 as shown. The base page 10a can be bound in a book or it can have a edge section 32 with perforations 32a, 32b and 32c which allow it to be held in a loose-leaf binder. Moreover, different coloring sheets and other foldable stencil panels can be provided on the opposite side of the page 10a to that shown in FIG. 2, whereby the coloring page is two sided.

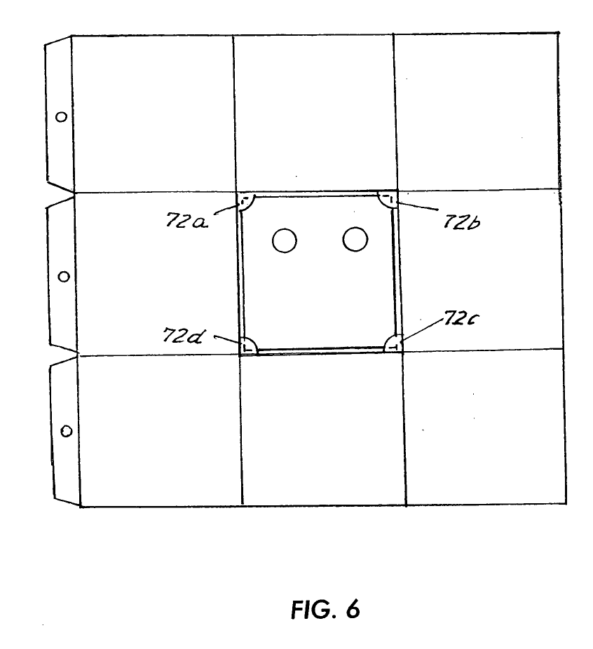

As shown in FIG. 6, the center of the page 10a can have edge pockets 72a-72d, in which different coloring sheets 12 can be inserted. Therefore a child can create a colored sheet and if the result is unsatisfactory, replace it with an identical coloring sheet, and try again. A child can also create several copies of the same work to show to different members of the family in order to further enhance the joy of the child and the delight of members of her or his family. Alternatively, several identical sheets may be provided at the center, and when a sheet is filled, it can be ripped off, revealing the one underneath it.

As described above, the coloring sheets and the book in which they can be incorporated, allow a child to create color pictures, or to create pictures from scratch, or to practice writing words, all for the purpose of creating more precisely rendered work and to train and develop a child's hand/eye coordination to the enjoyment of the child and her parents, teachers, friends and the like. The stencil panels can be provided with written instructions which indicate to the child how the stencils are to be used, and what colors or other steps are to be used. The stencils may be made of paper, plastic and of washable or non-washable materials, allowing the child or an adult to monitor the child's ability to keep the markings off the stencils.

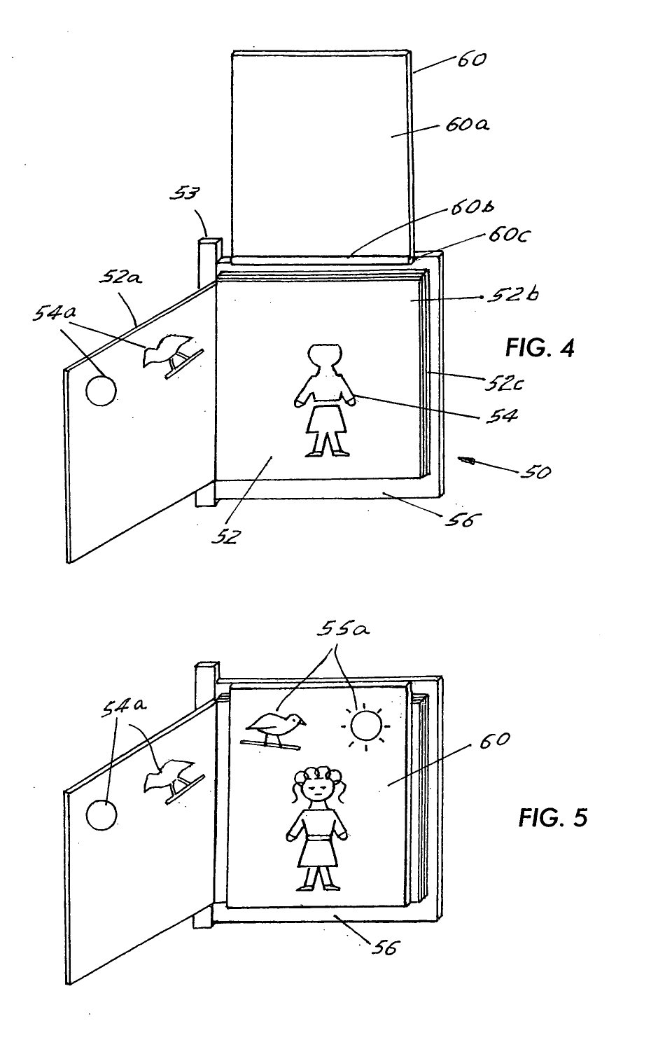

In the embodiment of FIG. 4, a coloring book 50 is provided with a plurality of stencils 52, including first stencil panel 52a, a second 52b, a third stencil 52c and so on, which are bound together in book or looseleaf binder at a binding 53, enabling the stencils to be turned similar to the pages of a book. Behind the set of the stencils is a base page 56 which has attached at an upper edge thereof a coloring page 60 which has a rear surface 60a. The coloring page 60 is foldable at folding edge 60c so it can be placed below any of the stencil pages 52, in perfect alignment with the stencil cutouts, such as the cutouts 54a on stencil 52a and 54b on stencil 52b. Alternatively, the coloring page 60 may be provided at 180° or at 270° orientations relative to the binding 53 of the coloring book.

The coloring page includes a small extension 60b which is glued or otherwise fastened to the base page 56. As noted, the coloring page can be folded underneath any of the stencil pages. For example, in FIG. 5, the coloring page 60 is shown folded below the stencil page 52a, with the cutouts 54a of the stencil 52a being alignable over a corresponding section 55a of the picture on the coloring page 60.

It will readily apparent to one of ordinary skill in the art, that a single coloring book can be provided with a plurality of the coloring pages 60, each with an associated set of stencils.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A coloring page, comprising:
a page having a plurality of sides and a plurality of image sections on the page, where the different sections are intended to be filled with various markings; and
a plurality of stencil panels, corresponding ones of said stencil panels being locatable relative to said page at corresponding ones of said sides of said page and each said stencil panels comprising a respective pattern corresponding to a respective one of said sections on said page, each said panel being foldable over said page at a respective fold line in a manner whereby said stencil is in registration with said respective section on said page, whereby a child is enabled to fold different ones of said panels over said page to color in or mark said different sections on said page without marking other sections.

2. The coloring page of claim 1, comprising four stencil panels respectively attached at four sides of said page.

3. The coloring page of claim 1, wherein the panels are comprised of a material stiffer than that of a material of said page.

4. The coloring page of claim 2, wherein the four sides of the page are either parallel or perpendicular to each other.

5. The coloring page of claim 4, including at least one additional panel which is located relative to said page at a corresponding corner region of said page, at a corresponding fold line, and the additional panel comprises a stencil that registers with a respective one of said sections on said page when the additional panel is folded over said page.

6. The coloring page of claim 1, including additional pages and corresponding panels having stencils formed thereon, wherein all the pages and their corresponding panels are bound together to form a book of such pages and corresponding stencil panels.

7. The coloring page of claim 1, comprising a base sheet and the coloring page and the stencil pencils being supported on said base sheet.

8. The coloring page of claim 7, including providing a coloring page and stencil panels on opposed sides of said sheet.

9. The coloring page of claim 7, including perforations in the sheet to enable the sheet and its coloring page and stencil panels to be held in a loose-leaf binder.

10. The coloring page of claim 1, wherein a plurality of replaceable coloring pages can be placed at a central location of the book.

11. A coloring book, comprising:
a plurality of stencil panels; and
a coloring page which is attached to the coloring book in a manner which enables the coloring page to be folded so as to be placed underneath any desired one of the stencil panels in a manner which enables a respective pattern on a selected stencil to become registered with a section of an image rendered on the coloring page, in a manner whereby a child is enabled to fold the coloring page underneath any of said panels to color in or mark said different sections on said coloring page without marking other sections.
